(19) United States
(12) Patent Application Publication
(10) Pub. No.: US 2005/0137980 A1
(43) Pub. Date: Jun. 23, 2005

(54) ACTIVE DISABLEMENT OF MALICIOUS CODE IN ASSOCIATION WITH THE PROVISION OF ON-LINE FINANCIAL SERVICES

(75) Inventors: Marilyn S. Bullock, Virginia Beach, VA (US); Mack Hicks, Palm Springs, CA (US); Rhonda MacLean, Sherrills Ford, NC (US)

Correspondence Address: MOORE & VAN ALLEN PLLC, P.O. BOX 13706, Research Triangle Park, NC, 27709, US

(73) Assignee: BANK OF AMERICA CORPORATION, Charlotte, NC (US)

(21) Appl. No.: 10/707,476

(22) Filed: Dec. 17, 2003

(51) Int. Cl. G06F 17/60

(52) U.S. Cl. 705/44

(57) ABSTRACT

Active disablement of malicious code in association with the provision of on-line financial services. The invention provides for the active detection and disablement of malicious code residing on a customer computer system used for conducting on-line financial transactions. Computer programs residing on a server of a financial institution, such as a bank, direct the download and execution of scanning software by the customer. The scanning is performed as an integral part of the on-line financial transaction process. Computer program instructions for scanning the customer computer system are activated over the network, in some embodiments, through the use of ActiveX controls.

### BACKGROUND OF INVENTION

The public data network commonly referred to as the Internet has become increasingly popular in recent years. This popularity has largely resulted from the ease of use that has been brought to the Internet by the advent of the Worldwide Web. A web browser, or simply, a browser, is a computer application program that provides access to vast Internet resources in a graphical format. A web browser also provides for the upload and download of information between a user's computer system and a server on the Internet. The speed and ease with which a browser can be used to exchange information has led to the use of the Worldwide Web for both personal and commercial business purposes, for example, the conducting of routine banking activities.

The ease with which the Internet can be accessed and used from a personal computer has also led to some problems. It has become increasingly common for “hackers” and other nefarious individuals to develop and propagate malicious computer code that can be installed on a user's personal computer unwittingly for malicious purposes. For example, certain types of “Trojan horses” can be used to gather personal information from a user's computer and forward that information to individuals or organizations who will make wrongful use of it. Viruses and worms can delete information, initiate Emails clogging networks and in some cases even damage storage media or otherwise reek havoc for a user. In the banking and finance arena, these risks present unique problems because financial information is so important to most users. Loss of such information can be a headache. In addition, this information can be used for identity theft, credit card fraud, and similar crimes. In the case of information theft, customers of financial institutions bear some risk, however, the ultimate liability for such crimes typically falls to the financial institutions. Current laws put most of the financial loss from identity theft and credit card fraud on the financial institutions affected. Furthermore, customers who are victims of malicious code will often bear ill will and resentment towards a bank or financial institution with which they were dealing when the incident occurred. Thus, financial institutions as well as their customers have a strong interest in securing personal information and protecting against malicious code.

### SUMMARY OF INVENTION

The present invention provides for the active disablement of malicious code residing on a customer computer system used for conducting on-line financial transactions. Computer programs residing on a server of a financial institution, such as a bank, direct the download and execution of scanning software by the customer computer system. The scanning is performed as an integral part of the on-line financial transaction process. In effect, the financial institution extends its information security perimeter around a customer when the customer is performing on-line financial transactions.

According to some embodiments of the invention, malicious code residing on a customer computer system is disabled in association with the provision of on-line financial services to the customer. After the customer has been authenticated for the on-line financial services, the customer is presented with an option to perform a scan of his or her computer system for the malicious code. Computer program instructions for scanning the customer computer system are activated over the network once the customer has selected the option to perform the scan. These instructions are directed to the detection and disablement of the malicious code. Once the scanning process is completed, the normal on-line financial transaction service is provided for the customer's use.

In some embodiments, a check is first made of the customer computer system to make sure that the scanning program is up-to-date and installed on the customer computer system. If the computer program that does the scanning needs to be updated or installed, it is down-loaded over the customer's network connection. In some embodiments, the checking for the presence of disablement routines and any downloading or updating, as well as the activation of the scanning program is accomplished through the use of ActiveX controls.

The invention, in its example embodiments, is implemented by various software and hardware means. Typically, a financial services institution maintains an on-line financial transaction server and a scanning server. These servers may be maintained on separate machines, or may reside on a single hardware platform. If these machines are on separate platforms, they operatively communicate with each other through communications network interfaces, typically over a local area network “LAN”. If ActiveX is used to deliver the scanning software to the customer computer system and execute it, the scanning server will typically include an ActiveX wrapper as well as a copy of the software which performs the scanning. In effect, the scanning engine is embodied in a computer program product as a first computer program, and the scanning software is embodied in the computer program product as a second computer program. On-line financial transactions are provided by the on-line financial transaction server through the use of computer program instructions which provide for these services over the Worldwide Web. When the scanning software is installed and run on a customer computer system, it provides the means to perform the scans. The various servers, computer systems, hardware elements, and computer program instructions work together to provide the means to carry out the invention in all of the example embodiments presented.

### BRIEF DESCRIPTION OF DRAWINGS

FIG. 1 is a flow chart, which illustrates the overall process according to example embodiments of the invention.

FIG. 2 is another flow chart, this time illustrating the detailed process of scanning for suspect code according to example embodiments of the invention.

FIG. 3 is a block diagram which illustrates the customer computer system and the various servers and computer program products that carry out embodiments of the invention, and also illustrates how these elements interact via the networks.

FIG. 4 is a screen shot illustrating how a customer might perform on-line banking with a financial institution which has implemented the invention.

### DETAILED DESCRIPTION

According to example embodiments of the invention presented herein, routines residing on the server or servers of a financial institution, such as a bank, direct the download and execution of scanning software by a customer computer system. The scanning is performed as an integral part of the on-line financial transaction process. The scanning software can dynamically scan the customer computer system for malicious code, including Trojan horses that can compromise the customer's financial information and/or viruses and worms that can disrupt the operation of the customer computer system. In effect, the financial institution extends its information security perimeter around a customer when the customer is performing on-line financial transactions.

The meaning of certain terms as used in the context of this disclosure should be understood as follows. The term “malicious code” and similar terms are in most cases intended to apply to Trojan horses, viruses, worms, and any other code introduced into a computer system to cause damage, or wrongfully obtain information from a computer system. The term “suspect code” is used to refer to computer program code instructions which appear to possibly be malicious code, but may in fact be legitimate. For example, all code discovered in a scan for malicious code and flagged as possibly malicious code, which may include false positives, is referred to as suspect code. Legitimate software which is carrying out the invention, or is otherwise known to be legitimately present on a computer system with the knowledge and intent of the system's owner or operator is generally referred to herein as a computer program, software, computer program instructions, or simply, “instructions”.

In some of the discussions presented herein, banking, or on-line banking may be referenced. Such terms are intended to encompass all types of on-line financial transactions performed relative to any financial institution. Thus, such terminology includes writing checks and balancing a checking account on-line with a bank, but also may include performing on-line stock trades at a brokerage. A server which is involved in supporting such transactions may be referred to as an on-line banking server, or an on-line financial transaction server, or simply a financial transaction server. A customer of the financial institution who is using a personal computer or workstation to access such a server over the Internet is referred to as an “customer” and their computer system is referred to as a “customer computer system.” It should also be noted that computer program instructions for scanning a customer computer system are referred to herein as being “downloaded” to the customer computer system. This term is intended to encompass the computer scanning program being sent from a server at the financial institution to the customer computer system, regardless of from which machine's point of view the discussion is from. It may also be said that software sent to a customer computer system is being “pushed” to the customer computer system.

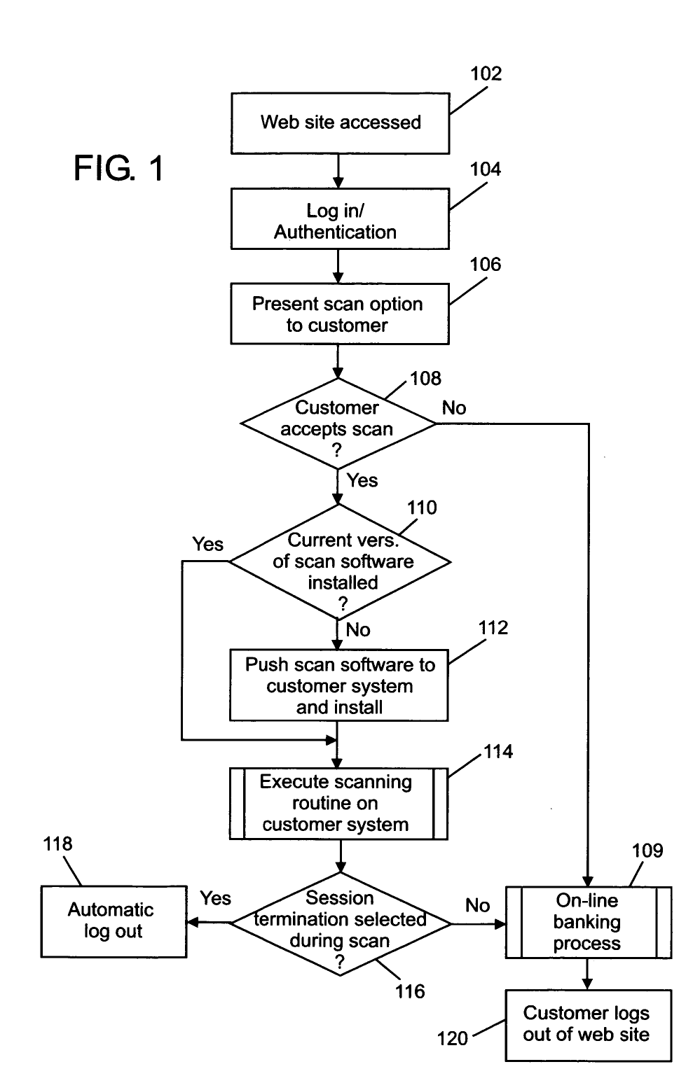

FIG. 1 is a flow chart that illustrates the high-level process flow in an embodiment of the invention. The process begins at block 102 when a customer accesses a secure web application, which requires authentication, typically via a log-in ID and password. At block 104 the login and authentication takes place. The customer is authenticated through an access control list or database in a manner that is well known in the art and does not merit further discussion. At block 106 the customer is presented with the option to scan for malicious code on his or her computer system. In most embodiments, the customer will be informed that the scan is to take place via a particular mechanism, in this example, an ActiveX control, which will be discussed in further detail below. The customer would typically also be informed that computer program software or instructions will be downloaded to his or her computer system if needed. The process branches at block 108 depending on the customer response. If the customer declines the scan, processing typically proceeds to block 110. At this point, the customer proceeds with on-line banking transactions. Several design decisions can be made by persons implementing the present invention as to whether the customer will be presented with the option to scan each time the customer logs in to make financial transactions. It is also possible that the customer will be able to choose by selecting a checkbox or button that states “don't ask me this again” or something similar.

If the customer accepts the option to scan his or her system at block 108, a check is made for the current version of the scanning software at block 110. If the current version of the scanning software is not present on the customer computer system, it is pushed, or downloaded, to the customer computer system at block 112. This may be required if the software is not present, for example if this is the first time the customer has logged on and accepted the scan option, or if the software is simply outdated. In any case, once the presence of the appropriate scanning routine at the customer computer system is ensured, the scanning routine is executed at block 114. Typically, the scanning software is activated at least in part, through the network from the financial institution server, in this example via an ActiveX control. As will be discussed later, during the scanning process the customer is given an option to end their session if Trojan horses are found. If the customer accepts this option at block 116, the customer is automatically logged out at block 118. If the customer does not accept this option at block 116, the on-line banking process, 110, takes place as before. In this case, the customer will log out of the web site when the banking process is complete, as shown at block 120.

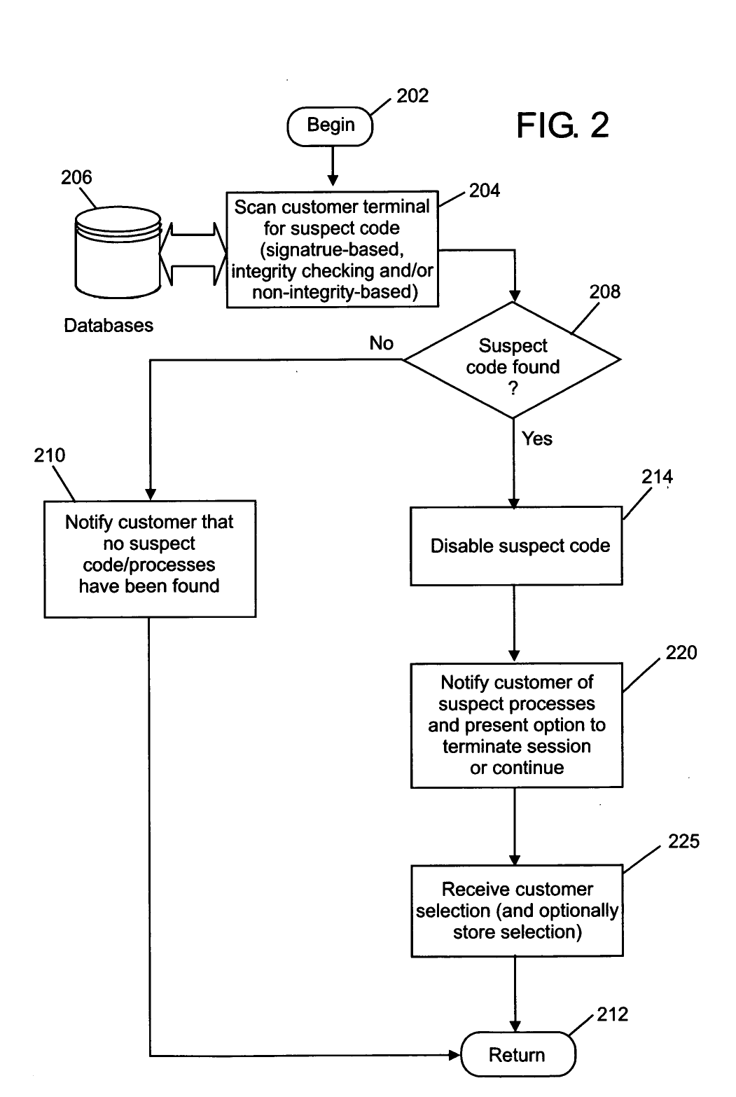

FIG. 2 illustrates a detailed flow chart showing the scanning process as it takes place after a customer has elected to proceed with a scan. Essentially, FIG. 2 breaks out the process referenced at 114 of FIG. 1. The process begins at 202. At block 204, the scanning program is run, which searches the computer system for malicious code. Depending on how the scanning algorithm works, reference may need to be made to an existing database or databases, for example, a database of virus signatures, a database of certain types of code behavior to flag, and/or a database of code that the customer has previously identified as safe or that has been “inoculated” as will be discussed later. The reference to these databases is conceptually illustrated at 206.

The program of FIG. 2 branches at block 208. If suspect code is not found at block 208, the customer is notified at block 210 that no suspect code or suspicious running processes have been found. At this point, the scanning routine ends and control is transferred to the on-line banking process at block 212. If suspect code is found at block 208, however, it is disabled at block 214. The customer is notified at block 220 of all occurrences of suspect code on his or her computer system. At this time, the customer is also presented with a choice to end the session, or proceed. At block 225, a decision is received from the customer. A customer might proceed, for example, if the customer knows that some of the code that the scanning software finds is actually legitimate and not malicious in nature. The scanning software can optionally have a check block or other indication in which the customer would indicate that the decision is to be remembered so that the suspect code is not flagged the next time a scan is performed. This can be handled in a matter similar to what is done with some software via a “remember this decision” indicator. This selection can then be stored in a database as part of the process shown at block 225. Control returns at block 212 to the on-line banking process and the customer is automatically logged off at block 118 of FIG. 1.

It should be noted that various types of scanning algorithms can be used to perform the scan of the customer computer system according to the invention. Some examples are given in block 204 of FIG. 2, which lists, as examples only, signature-based, integrity checking, and non-integrity based unknown code detection methods. Malicious code detection technology may be divided into categories such as signature scanning, integrity checking, and non-integrity-based unknown code detection, which includes heuristics and behavior-based detection. Any of these types of scanning and detection techniques can be used with the present invention. Signature scanning programs work by scanning files for signatures of known viruses or other malicious code. A signature is a sequence of bytes that may be found in the malicious program code, yet is unlikely to be found elsewhere. Signature-based systems have been in existence from many years and are well known. Commercial products that use signature-based technology have been marketed by companies such as International Business Machines Corp., Symantec Corp. and Network Associates Technology, Inc. Such scanning programs typically look for known Trojan horses, worms, viruses, and other types of malicious code, all of which are often referred to as “viruses” in the personal computer vernacular, hence such programs are often referred to simply as anti-virus programs. However, with signature-based techniques, only viruses whose signatures have already been determined and stored in the signature database may be detected using signature scanning. Moreover, the signature database must be updated frequently to detect the latest viruses. With the present invention, such a signature database can be updated every time a customer transacts business on a financial services web site and makes use of the scanning capabilities available according to embodiments of the invention.

Integrity checking (called “inoculation” by the commercial Norton™ Anti-Virus product from Symantec Corp.) is a technique in which “snapshots” or “fingerprints” are taken of programs (executable files, boot records) on the computer under the assumption that all these files are in an uninfected state. These fingerprints are typically taken after the computer has been scanned with a scanner that reasonably assures the computer is virus-free. These fingerprints are then saved into a database for later integrity-based scans. During subsequent integrity-based scans of the computer, the antivirus program verifies that each previously fingerprinted program on the computer matches its fingerprint. If a program does not match its fingerprint, then the antivirus program typically uses artificial intelligence to determine if the modification is malicious or merely a valid program update. In some cases, if the scanning software is still unsure, it asks the user to verify whether the new or changed program is legitimate. An integrity checking system can be adapted for use in the context of the invention by making a record of the code the customer has installed in the databases when a customer first access the financial services web site and makes use of the scanning services.

Non-integrity-based unknown malicious code detection is used to detect new and unknown viruses, worms, and/or Trojan horses without any integrity information. For example, a heuristic scanning program can examine a target program (executable file, boot record, or possibly document file with a macro) and analyzes its program code to determine if the code appears malicious. If the target program's code appears malicious, then the possible infection is reported to the user. At least some non-integrity-based detection can detect new and unknown malicious code that has not yet been analyzed for signatures. Because these techniques do not use integrity information, they do not require fingerprints of programs to be taken and saved when the computer is in a known clean state. Behavior-based scanning routines are also non-signature based and may be heuristic. U.S. Pat. No. 6,357,008 to Nachenberg discusses a heuristic method that involves looking at code behavior and is incorporated herein by reference. Products using behavior-based techniques that can detect previously unknown viruses are available from multiple vendors, which may include those previously listed, as well as WholeSecurity, Inc. of Austin, Tex. Some of these products detect multiple types of malicious code; some may be specific to Trojan horses or one or more other specific type of malicious code.

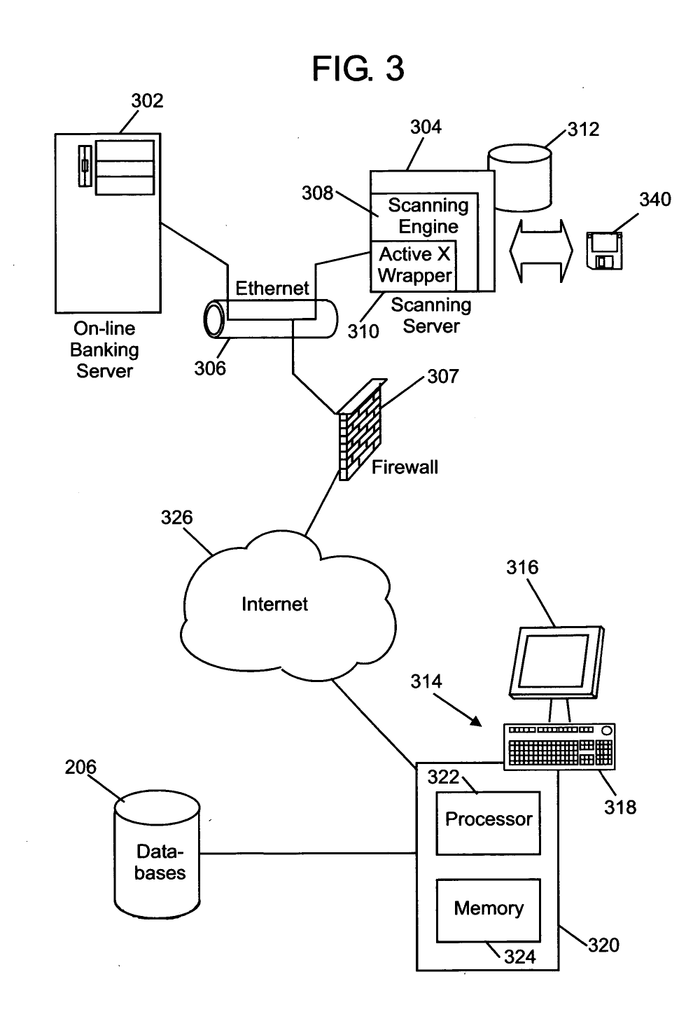

Turning to FIG. 3, a network block diagram showing the systems involved in implementing embodiments of the invention is shown. In this example, it can be assumed that the financial institution is a bank. Thus, on-line financial transaction server 302 is an on-line banking server. The bank also maintains scanning server 304. These servers are connected via an Ethernet local area network (LAN), 306. As is the case with most businesses, these resources are located behind an Internet firewall 307. The on-line banking server and the scanning server are shown in this example as implemented on separate hardware platforms, however, they could just as easily be implemented on a single platform. Scanning server 304 includes scanning engine 308, and ActiveX wrapper 310. The scanning engine includes the computer program to interact with customer computer systems and download a scanning computer program to those systems. The ActiveX wrapper, 310, allows remote activation of scanning routines over the network. ActiveX will be discussed in further detail below. Computer program instructions to implement the various functions of the invention reside partly in memory of scanning server 304 when it is in operation. They are permanently stored in a media such as a fixed disc drive shown conceptually at 312.

A customer computer system represented by a conceptual block diagram is shown at 314. Such a system typically includes display 316, keyboard 318, and a processing platform as shown at 320. The processing platform includes one or more processors 322, and a certain amount of memory, 324. The customer computer system creates and maintains any needed databases on the storage available locally. These are the same databases, 206, as discussed with reference to FIG. 2. The customer computer system accesses the bank's servers via the Internet, 326.

It should be noted that although ActiveX has been discussed in the context of the example embodiments presented herein, the invention is not limited to the use of ActiveX for downloading and activating scanning software installed on customer computer systems. Scripting languages which are completely unrelated to ActiveX could also be used. ActiveX features full access to Microsoft's Windows™ operating system. This access gives ActiveX controls more power than objects in at least some other scripting languages, at least for Windows-based customer computer systems. An ActiveX control can be automatically downloaded and executed by a web browser on a Windows-based system. ActiveX, unlike for example, Java, is not a programming language, but rather a set of rules for how applications share information. Related to ActiveX is the scripting language Visual Basic Script that enables web servers to embed interactive elements in web documents. Thus, ActiveX controls can be used to remotely execute software through a browser over the Internet.

It should be noted that customers may access a web site making use of the invention with non-Windows platforms, for example UNIX or LINUX computer systems. Such customers will not see the option to scan their system for malicious code if ActiveX is used to implement the invention, however, techniques can be used which would allow the invention to work with such non-Windows platforms. For example, if a person of ordinary skill in the art wishes to implement the invention in a manner that will allow scanning of non-Windows platforms, other types of scripting languages can be used, for example, Java. In the case of ActiveX, the ActiveX wrapper referred to in the context of FIG. 3 encapsulates the computer program instructions which perform the scan. In the case of another scripting language, another type of wrapper might be used.

It should be noted that computer program instructions, including a first computer program which operates primarily on the scanning server, and a second computer program, which serves as the scanning program, implement at least parts of most processes involved with carrying out the invention described herein. Such computer software can be supplied via a computer program product containing the program instructions supplied on a media, such as the media conceptually illustrated at 340 of FIG. 3, which is a removable disc. However, the computer programs can reside on any medium that can contain, store, communicate, propagate, or transport the program for use by or in connection with any type of computing platform or instruction execution system. Such a computer readable medium may be for example, but not limited to, an electronic, magnetic, optical, electromagnetic, infrared, or semiconductor system or device. Computer program instructions which implement the invention may also be embodied in a stream of information being retrieved over a network such as the Internet. Note that the computer usable or computer readable medium could even be paper or another suitable medium upon which the program is printed, as the program can be electronically captured via, for instance, an optical scan, then compiled and interpreted, or otherwise processed in a suitable manner.

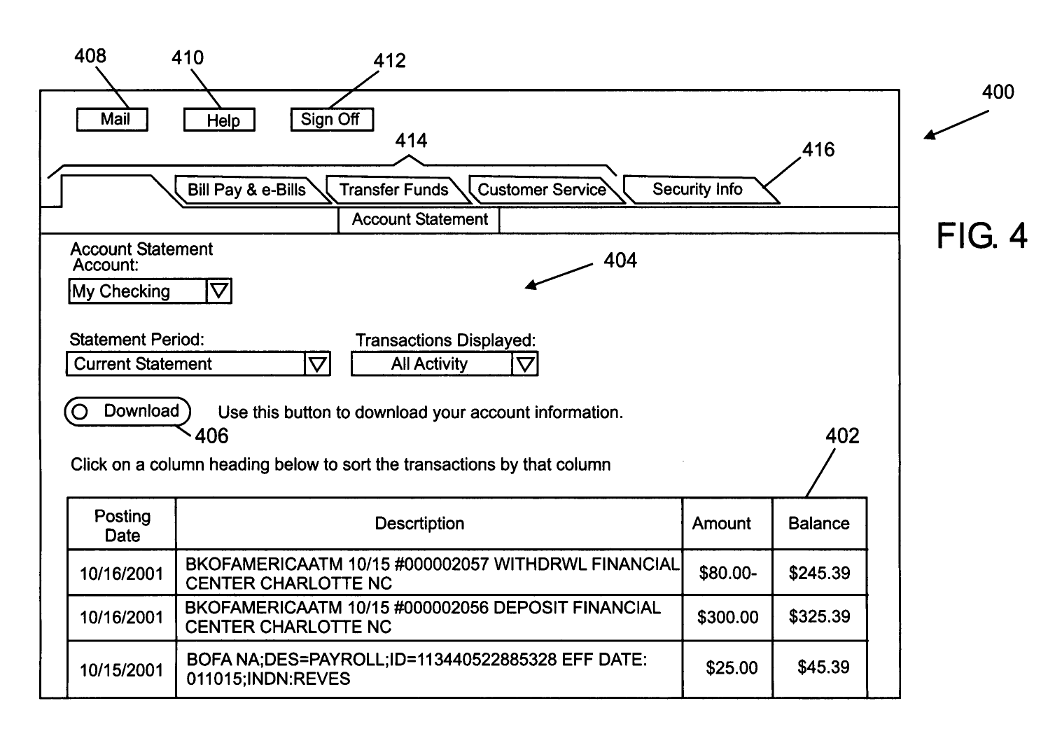

FIG. 4 illustrates an on-line banking screen, 400, as would be displayed in a web browser when a user begins on-line banking activities after a scan according to the present invention has been completed. Most elements in this screen, 400, are typical and well understood in the art, and thus require very little explanation. A statement of the account is shown at 402. Various drop-downs and buttons whose functions are relatively self-explanatory are shown at 404. A download button 406, is used to download transactions to the customer computer system. A customer can E-mail customer service with button 408, obtain help with button 410, and sign off with button 412. Tabs near the top of the display such as the ones shown at 414 provide access to typical functions. However, an additional tab, 416, is shown in this particular screen display. A customer can click this “security info” tab to view information about the scanning process according to the invention if it is implemented by the bank which is providing the on-line banking service illustrated in FIG. 4.

Specific embodiments of an invention are described herein. One of ordinary skill in the computing and networking arts will quickly recognize that the invention has other applications in other environments. Many embodiments are possible. The following claims are in no way intended to limit the scope of the invention to the specific embodiments described above.

1. A method of disabling malicious code residing on a customer computer system in association with providing on-line financial services to a customer through a network, the method comprising:
authenticating the customer for the on-line financial services;
presenting to the customer an option to perform a scan of the customer computer system for the malicious code;
executing, at least in part by activation over the network and upon receiving from the customer a selection of the option to perform the scan, computer program instructions for performing the scan, the computer program instructions being directed to detection and disablement of the malicious code; and
providing the on-line financial services to the customer.

2. The method of claim 1 wherein the executing of the computer program instructions further comprises downloading the computer program instructions to the customer computer system.

3. The method of claim 2 wherein the executing of the computer program instructions is accomplished at least in part through the use of an ActiveX control.

4. The method of claim 2 wherein the computer program instructions are operable to perform signature-based detection of the malicious code.

5. The method of claim 2 wherein the computer program instructions are operable to perform integrity checking.

6. The method of claim 2 wherein the computer program instructions are operable to perform non-integrity-based unknown malicious code detection.

7. The method of claim 3 wherein the computer program instructions are operable to perform signature-based detection of the malicious code.

8. The method of claim 3 wherein the computer program instructions are operable to perform integrity checking.

9. The method of claim 3 wherein the computer program instructions are operable to perform non-integrity-based unknown malicious code detection.

10. Apparatus for disabling malicious code residing on a customer computer system in association with providing on-line financial services to a customer through a network, the apparatus comprising:
means for authenticating the customer for the on-line financial services;
means for executing, at least in part by activation over the network, computer program instructions for performing a scan for the malicious code, the computer program instructions being directed to detection and disablement of the malicious code; and
means for providing the on-line financial services to the customer.

11. The apparatus of claim 10 wherein the means for executing the computer program instructions further comprises means for downloading the computer program instructions to the customer computer system.

12. The apparatus of claim 11 wherein the means for executing the computer program instructions further comprises an ActiveX control.

13. A computer program product for disabling malicious code residing on a customer computer system in association with providing on-line financial services to a customer through a network, the computer program product comprising a first computer program and a second computer program, the first computer program further comprising:
instructions for authenticating the customer for the on-line financial services;
instructions for presenting to the customer an option to perform a scan of the customer computer system for the malicious code;
instructions for executing, at least in part through activation over the network and upon receiving from the customer a selection of the option to perform the scan, the second computer program for performing the scan, the second computer program being directed to detection and disablement of the malicious code; and
instructions for providing the on-line financial services to the customer.

14. The computer program product of claim 13 wherein the instructions for executing the second computer program further comprise instructions for downloading the second computer program to the customer computer system.

15. The computer program product of claim 14 wherein the instructions for executing the second computer program further comprise an ActiveX control.

16. The computer program product of claim 14 wherein the second computer program is operable to perform signature-based detection of the malicious code.

17. The computer program product of claim 14 wherein the second computer program is operable to perform integrity checking.

18. The computer program product of claim 14 wherein the second computer program is operable to perform non-integrity-based unknown malicious code detection.

19. The computer program product of claim 15 wherein the second computer program is operable to perform signature-based detection of the malicious code.

20. The computer program product of claim 15 wherein the second computer program is operable to perform integrity checking.

21. The computer program product of claim 15 wherein the second computer program is operable to perform non-integrity-based unknown malicious code detection.

22. An on-line financial system comprising:
at least one network connection;
an on-line financial transaction server operable to provide on-line financial services to customers; and
a scanning server operatively connected to the at least one network connection and to the on-line financial transaction server, the scanning server operable to disable malicious code residing on a customer computer system in association with the providing of the on-line financial services, by executing, at the customer computer system, at least in part by activation over the network connection, computer program instructions directed to detection and disablement of the malicious code.

23. The system of claim 22 wherein the scanning server further comprises the computer program instructions, and wherein the scanning server is further operable to download to computer program instructions to the customer computer system.

24. The system of claim 23 wherein the scanning server further comprises an ActiveX wrapper and wherein the scanning server is further operable to execute the computer program instructions at the customer computer system using an ActiveX control.

25. The system of claim 23 wherein the computer program instructions are operable to perform signature-based detection of the malicious code.

26. The system of claim 23 wherein the computer program instructions are operable to perform integrity checking.

27. The system of claim 23 wherein the computer program instructions are operable to perform non-integrity-based unknown malicious code detection.

28. The system of claim 24 wherein the computer program instructions are operable to perform signature-based detection of the malicious code.

29. The system of claim 24 wherein the computer program instructions are operable to perform integrity checking.

30. The system of claim 24 wherein the computer program instructions are operable to perform non-integrity-based unknown malicious code detection.
